(19) United States
(12) Patent Application Publication
(10) Pub. No.: US 2017/0305204 A1
(43) Pub. Date: Oct. 26, 2017

(54) PNEUMATIC VEHICLE TYRE COMPRISING A CARCASS

(71) Applicant: Continental Reifen Deutschland GmbH, Hannover (DE)

(72) Inventors: Julian De Riva-Perez, Hannover (DE); Peter Voelsen, Garbsen (DE)

(73) Assignee: Continental Reifen Deutschland GmbH, Hannover (DE)

(21) Appl. No.: 15/517,970

(22) PCT Filed: Jul. 1, 2015
(86) PCT No.: PCT/EP2015/064932

§ 371 Date: Apr. 10, 2017

(30) Foreign Application Priority Data
Oct. 31, 2014 (DE) 10 2014 222 306.7

(51) Int. Cl. B60C 15/00; B60C 9/02; B60C 9/04

(52) U.S. Cl. CPC B60C 15/0018; B60C 9/0238; B60C 9/0207; B60C 2009/0416; B60C 2009/0246

(57) ABSTRACT

Pneumatic vehicle tyre comprising a carcass (3), wherein the carcass (3) has two carcass plies (31, 32), wherein each carcass ply (31, 32) has reinforcements which are arranged inside the carcass ply (31, 32) substantially parallel to each other. The problem addressed by the invention is to provide a pneumatic vehicle tyre which likewise creates a high quality impression of sufficient robustness to a viewer and, in the process, is cheaper to produce and has a reduced rolling resistance. The invention is characterised in that the product EF1 of the average modulus of elasticity of the reinforcements, as measured with an extension of 2%, of the first carcass ply (31) and the thread density of the reinforcements of the first carcass ply (31), and the product EF2 of the average modulus of elasticity of the reinforcements of the second carcass ply (32) and the thread density of reinforcements of the second carcass ply (32), satisfy the relationship EF1>EF2.

The invention relates to a pneumatic vehicle tyre having at least one profiled tread, a belt, two side walls, two bead cores and a carcass, wherein the carcass has two carcass plies, wherein each carcass ply has reinforcement members which are arranged substantially parallel to one another within the carcass ply and which are embedded in elastomer material, wherein the first carcass ply runs in coherent fashion and, in so doing, extends at least from one bead core to the other bead core, runs around each bead core from axially inside to axially outside, and extends in a carcass upturned portion in the direction of the belt, and wherein, at least in the region of a belt edge, the second carcass ply is arranged radially outside the first carcass ply.

A pneumatic vehicle tyre generally has an inner layer which is impermeable to air, a carcass comprising reinforcement members, which carcass extends from the zenith region of the tyre via the side walls into the bead regions and is normally anchored there by being looped around tension-resistant bead cores, a radially externally situated profiled tread, and a belt arranged between the tread and the carcass, which belt normally comprises at least two reinforcement member plies and is covered radially at the outside by the belt bandage.

The reinforcement members of the carcass plies are, during the production process, embedded by calendering into a rubber mixture in order to be able to be used as a rubberized reinforcement member ply in the tyre. The reinforcement members in carcass plies must exhibit adequate strength in order to be able to adequately withstand the forces that arise during the operation of the tyre and in order to be durable. In particular, the carcass provides resistance to the internal pressure of the tyre and has the function of a reinforcement member. Use is normally made here of textile reinforcement members such as textile yarns or textile cords, or steel cords.

A single-ply carcass is simple and inexpensive to produce. Adequate robustness of the tyre however cannot always be ensured by way of such a construction. Also, tyres with a single-ply carcass may have constrictions, which are visible to the user, in the side walls in the regions of the overlapping connections of the carcass ply, whereby the high-quality impression of the tyre is reduced.

Tyres are known which have two carcass plies, wherein the two carcass plies differ only in terms of their dimensions and arrangement. A two-ply construction of said type exhibits greater strength and greater stiffness, whereby the robustness and durability of the tyre are improved in relation to a single-ply construction. The effect of the constriction of the side wall is also reduced in this way. A second ply of said type is however associated with considerable additional material outlay, which has an adverse effect on the material costs, the weight and the rolling resistance of the tyre.

It is the object of the invention to provide a pneumatic vehicle tyre which, while exhibiting adequate robustness, likewise gives a high-quality impression to an observer and, at the same time, is less expensive to produce and has a reduced rolling resistance.

The object is achieved in that the product EF1 of the mean modulus of elasticity of the reinforcement members of the first carcass ply and the strand density of the reinforcement members of the first carcass ply and the product EF2 of the mean modulus of elasticity of the strength members of the second carcass ply and the strand density of the reinforcement members of the second carcass ply satisfy the relationship EF1>EF2, preferably the relationship 1.5×EF2≧EF1≧1.3×EF2, wherein the modulus of elasticity of a reinforcement member is in each case measured at an elongation of 2% in accordance with ASTM D885. Here, the force that must be applied in each case to the reinforcement members at an elongation of 2% is determined. Here, it is expedient if all of the reinforcement members of a carcass ply have the same modulus of elasticity. However, if a carcass ply has reinforcement members with different moduli of elasticity, the average modulus of elasticity of the reinforcement members of the respective ply is determined as an arithmetic mean. The strand density indicates how many reinforcement members are arranged per unit of length perpendicular to the extent of the reinforcement members. The products EF1 and EF2 thus correspond to the cumulated modulus of elasticity of the reinforcement members arranged per unit of length (of the strand density), and thus define the stretchability of the reinforcement members arranged to form the reinforcement member ply of the respective carcass ply. Said stretchability of the reinforcement member plies in turn serves as an indicator for the stretchability of the respective carcass ply having a reinforcement member ply of said type.

The first carcass ply and the second carcass ply differ by their products EF1 and EF2, wherein the first carcass ply has a greater product of modulus of elasticity and strand density than the second carcass ply. The reinforcement member ply of the first carcass ply thus exhibits lower stretchability than the reinforcement member ply of the second carcass ply. The focusing of the forces that arise during the operation of the tyre, and the structural durability of the tyre, are ensured predominantly by way of the first carcass ply. Through the selection of the product EF2 of the second carcass ply, the reinforcement of the carcass by the second carcass ply, in particular the stretchability and stiffness of the carcass, can be set in a flexible manner, and a reinforcement of the tyre is realized only to the extent required for ensuring factors such as stretchability, robustness and side wall constriction. Owing to the lower demands placed on the second carcass ply, it is furthermore the case that material costs and tyre weight are reduced, while the advantages of a second carcass ply are maintained. Thus, a pneumatic vehicle tyre is provided which, while exhibiting adequate robustness, likewise gives a high-quality impression to an observer and, at the same time, is less expensive to produce and, owing to the weight saving, has a reduced rolling resistance.

It is advantageous if the reinforcement members of the first carcass ply and the reinforcement members of the second carcass ply are formed from the same material. The reinforcement members of the two carcass plies thus have identical material characteristics.

In a further preferred embodiment, the product FF1 of the mean fineness of the reinforcement members of the first carcass ply and the strand density of the reinforcement members of the first carcass ply and the product FF2 of the mean fineness of the reinforcement members of the second carcass ply and the strand density of the reinforcement members of the second carcass ply satisfy the relationship FF1>FF2, preferably the relationship 1.5×FF2≧FF1≧1.3×FF2. The fineness is a measure for the weight of the reinforcement member per length of the reinforcement member. Here, it is expedient if all of the reinforcement members of a carcass ply have the same fineness. However, if a carcass ply has reinforcement members with different fineness, the average fineness of the reinforcement members of the respective ply is determined as an arithmetic mean. The products FF1 and FF2 thus correspond to the cumulated fineness of the reinforcement members arranged per unit of length (of the strand density), and thus define the stretchability of the reinforcement members arranged to form the reinforcement member ply of the respective carcass ply. By way of such a combination of carcass plies, a reduction in material usage is effected in a simple manner, while maintaining adequate robustness of the pneumatic vehicle tyre.

A particularly simple embodiment is realized if all of the reinforcement members of a carcass ply are of identical form. A particularly simple embodiment is also realized if the two carcass plies differ only in terms of the fineness of the reinforcement members or in terms of the strand density of the reinforcement members or in terms of the modulus of elasticity of the reinforcement members.

It is also advantageous if the second carcass ply extends in coherent fashion at least from one bead core to the other bead core. By way of this particularly simple construction, it is ensured that the reinforcement of the carcass by way of the second carcass ply is ensured on both tyre halves for the entire extent between bead core and belt. The region between bead core and belt is of particular significance for ensuring the robustness and for the side wall constriction.

A further advantageous carcass construction is realized if the second carcass ply is a split ply composed of two ply parts, if, at least from the radially outer height of each bead core, a ply part runs in a radial direction in the direction of the belt, is led as far as under the belt and ends there, and if the two ply parts are arranged axially spaced apart from one another in the belt region. The spacing-apart of the two ply parts leads to an additional reduction of the material usage for the second carcass ply. In this way, the advantages of the two-ply construction in the crucial side wall region are maintained, while material usage is reduced. The reduced material usage results in lower production costs and in a weight saving and in a reduced rolling resistance.

Heights are measured from the radially inner end of the bead core. The “radially outer height of a bead core” is the height of the radially outer end of the bead core.

It is also expedient if the second carcass ply is formed only on one tyre half, preferably if the second carcass ply is formed only on that tyre outer half which points toward the vehicle exterior in the installed state on the vehicle.

It is preferable if the second carcass ply at least in one tyre half runs in the region of the carcass upturned portion of the first carcass ply and axially outside the carcass upturned portion of the first carcass ply. Here, a symmetrical arrangement of the carcass plies with respect to the tyre halves is expedient.

It is also preferable if the second carcass ply at least in one tyre half runs in the region of the carcass upturned portion of the first carcass ply and axially within the carcass upturned portion of the first carcass ply. The second carcass ply may end axially within or axially outside the bead core without looping around the bead core, or may be looped around the bead core from axially outside or from axially inside and end in a carcass upturned portion. Here, too, a symmetrical arrangement of the carcass plies with respect to the tyre halves is expedient.

It is also advantageous if the reinforcement members of the two carcass plies, with opposite gradient direction, enclose an approximately equal angle of 70° to 90°, preferably an approximately equal angle of 85° to 90°, with the circumferential direction of the pneumatic vehicle tyre. In this way, a side wall constriction, resulting from the overlapping connection of a ply, by the respective other ply is reduced in a particularly effective manner.

It has proven to be expedient, if the reinforcement members of both carcass plies are formed from cords composed of the same material, for the cords of the first carcass ply to be formed from two yarns with a fineness of 1440 dtex which are twisted together at the ends and which are arranged with a strand density of 105 epdm, and if the cords of the second carcass ply are formed from two yarns with a fineness of 1100 dtex which are twisted together at the ends and which are arranged with a strand density of 100 epdm.

A tyre of said type is extremely highly suitable as a tyre for passenger motor vehicles and utility vehicles, preferably for passenger motor vehicles.

Further features, advantages and details of the invention will now be discussed in more detail on the basis of the drawings, which illustrate schematic exemplary embodiments. In the drawings:

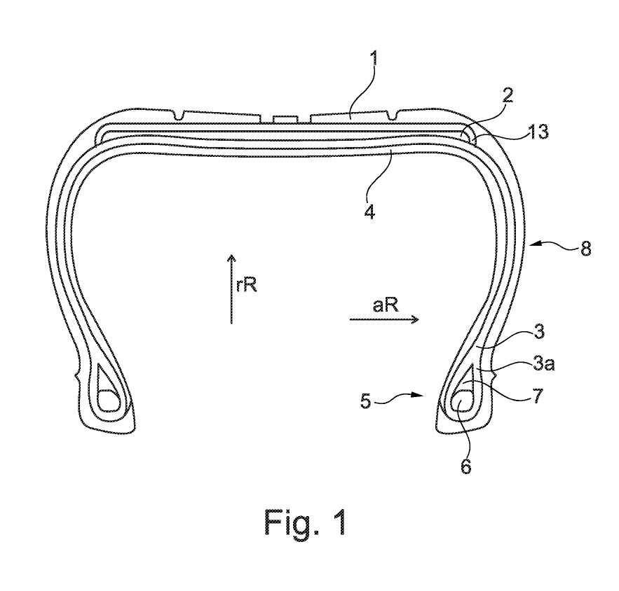

FIG. 1 shows a cross section through a passenger motor vehicle tyre;

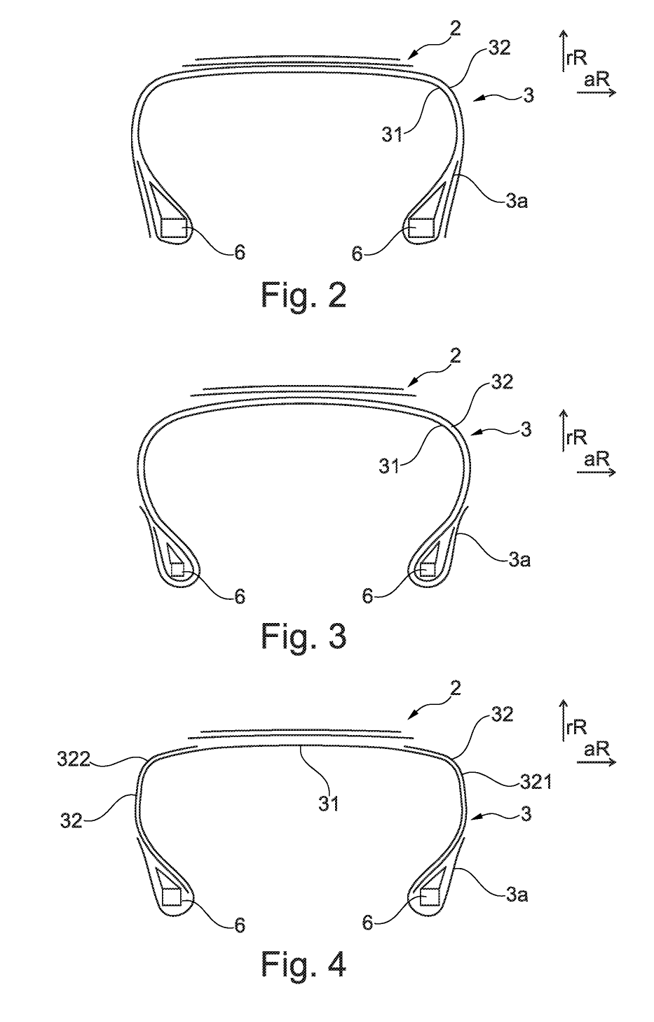

FIG. 2 shows a cross section through an overlapping connection of a carcass ply of a passenger motor vehicle tyre according to the invention;

FIG. 3 and FIG. 4 each show a cross section through an exemplary embodiment of the carcass arrangement in a passenger motor vehicle tyre.

FIG. 1 schematically shows a cross section through a passenger motor vehicle pneumatic tyre. The major constituent parts from which the illustrated tyre is constructed are a profiled tread 1, a belt 2 which is covered radially at the outside by a belt bandage 13, an inner layer 4 which is of substantially air-tight form, beads 5 with bead cores 6 and bead core profiles 7, side walls 8, and a carcass 3 which extends from one bead core 6 to the other bead core 6 and is looped around these. The carcass 3 is of two-ply form, wherein the carcass plies are not illustrated individually in FIG. 1. The belt 2 has two plies (not illustrated in any more detail) which, in a known manner, have reinforcement members composed of steel cord which are embedded in a rubber mixture, which reinforcement members run parallel to one another within each ply. The steel cords of one ply are in this case oriented in a criss-crossing arrangement with respect to the steel cords of the second ply. The carcass 3 also has reinforcement members which are embedded in elastomer material and which run in a radial direction and which are composed of a textile material or of steel cord, which reinforcement members are arranged substantially parallel to one another within each carcass ply, and wherein each carcass ply is of closed form in a circumferential direction of the pneumatic vehicle tyre.

FIG. 2 to FIG. 4 each show a cross section through an exemplary embodiment of a carcass ply arrangement in a passenger motor vehicle tyre. The carcass ply arrangements that are shown are suitable for the passenger motor vehicle tyre shown in FIG. 1.

In FIG. 2 to FIG. 4, the first carcass ply 31 runs in coherent fashion and extends in this case at least from one bead core 6 to the other bead core 6. Furthermore, the first carcass ply 31 runs around each bead core 6 from axially inside to axially outside and extends, in a carcass upturned portion 3a, in the direction of the belt 2. In the regions of the two belt edges, the second carcass ply 32 is arranged radially outside the first carcass ply 31. The arrangement of the two carcass plies 31, 32 is symmetrical with respect to the tyre halves. All of the reinforcement members of the first carcass ply 31 are of identical form. All of the reinforcement members of the second carcass ply 32 are also of identical form. The reinforcement members of the two carcass plies 31, 32, with opposite gradient direction, enclose an approximately equal angle of 85° to 90°, with the circumferential direction of the pneumatic vehicle tyre.

In FIG. 2, the second carcass ply 32 also extends in coherent fashion at least from one bead core 6 to the other bead core 6. The second carcass ply 32 runs, in the region of the carcass upturned portion 3a of the first carcass ply 31, axially outside the carcass upturned portion 3a of the first carcass ply 31, and ends there without being looped around the bead core 6.

The product EF1 of the mean modulus of elasticity of the reinforcement members of the first carcass ply 31 and the strand density of the reinforcement members of the first carcass ply 31 and the product EF2 of the mean modulus of elasticity of the strength members of the second carcass ply 32 and the strand density of the reinforcement members of the second carcass ply 32 satisfy the relationship 1.5×EF2≧EF1≧1.3×EF2, wherein the modulus of elasticity of a reinforcement member is in each case measured at an elongation of 2% in accordance with ASTM D885. Furthermore, the product FF1 of the mean fineness of the reinforcement members of the first carcass ply 31 and the strand density of the reinforcement members of the first carcass ply 31 and the product FF2 of the mean fineness of the reinforcement members of the second carcass ply 32 and the strand density of the reinforcement members of the second carcass ply 32 satisfy the relationship 1.5× FF2≧FF1≧1.3×FF2.

In FIG. 3, too, the second carcass ply 32 extends in coherent fashion at least from one bead core 6 to the other bead core 6. The second carcass ply 32 runs, in the region of the carcass upturned portion 3a of the first carcass ply 31, axially within the carcass upturned portion 3a of the first carcass ply, and is looped around the bead core 6 from axially inside to axially outside.

Here, the reinforcement members of the two carcass plies 31, 32 are composed of polyester. The product EF1 and the product EF2 approximately satisfy the relationship EF1=1.4× EF2. Furthermore, the product FF1 and the product FF2 satisfy the relationship 1.5× FF2≧FF1≧1.3×FF2. The reinforcement members of the first carcass ply 31, with an equal and opposite gradient angle, enclose an angle of approximately 89° with the circumferential direction of the pneumatic vehicle tyre.

In FIG. 4, the second carcass ply 32 is a split ply composed of two ply parts 321, 322. From the radially outer height of each bead core 6, a ply part 321, 322 runs in the radial direction toward the belt 2. The ply parts 321, 322 are led as far as under the belt 2 and end there. Here, the two ply parts 321, 322 are arranged spaced apart from one another in the region of the belt 2. In the region of the carcass upturned portion 3a of the first carcass ply 31, the second carcass ply 32 runs axially within the carcass upturned portion 3a of the first carcass ply 31 and axially within the bead core 6, and ends there without being looped around the bead core 6.

Here, the reinforcement members of the first carcass ply 31 and the reinforcement members of the second carcass ply 32 are composed of polyester. The reinforcement members of the first carcass ply 31 are cords composed of two yarns with a fineness of 1440 dtex which are twisted together at the ends and which are arranged with a strand density of 105 epdm. The reinforcement members of the second carcass ply 32 are cords composed of two yarns with a fineness of 1100 dtex which are twisted together at the ends and which are arranged with a strand density of 100 epdm. The reinforcement members of the two carcass plies 31, 32, with opposite gradient direction, enclose an approximately equal angle of approximately 86° with the circumferential direction of the tyre.

### LIST OF REFERENCE SIGNS

### (Part of the Description)

1 Tread
2 Belt
3 Carcass
3a Carcass upturned portion
4 Inner layer
5 Bead
6 Bead core
7 Bead core profile
8 Side wall
13 Belt bandage
31 First carcass ply
32 Second carcass ply
321, 322 Ply part of the second carcass ply
rR Radial direction

1.-9. (canceled)

10. A pneumatic vehicle tire comprising at least one profiled tread, a belt, two side walls, two bead cores and a carcass, wherein the carcass has two carcass plies, wherein each carcass ply has reinforcement members which are arranged substantially parallel to one another within the carcass ply and which are embedded in elastomer material, wherein the first carcass ply runs in coherent fashion and, in so doing, extends at least from one bead core to the other bead core, runs around each bead core from axially inside to axially outside, and extends in a carcass upturned portion in the direction of the belt, and wherein, at least in the region of a belt edge, the second carcass ply is arranged radially outside the first carcass ply; and,
wherein a product EF1 of mean modulus of elasticity of the reinforcement members of the first carcass ply and strand density of the reinforcement members of the first carcass ply, and a product EF2 of mean modulus of elasticity of strength members of the second carcass ply and strand density of the reinforcement members of the second carcass ply, satisfy the relationship EF1>EF2, and wherein the modulus of elasticity of a reinforcement member is in each case measured at an elongation of 2% in accordance with ASTM D885.

11. The pneumatic vehicle tire as claimed in claim 1, wherein the reinforcement members of the first carcass ply and the reinforcement members of the second carcass ply are formed from the same material.

12. The pneumatic vehicle tire as claimed in claim 1, wherein a product FF1 of mean fineness of the reinforcement members of the first carcass ply and the strand density of the reinforcement members of the first carcass ply, and a product FF2 of mean fineness of the reinforcement members of the second carcass ply and the strand density of the reinforcement members of the second carcass ply, satisfy the relationship FF1>FF2.

13. The pneumatic vehicle tire as claimed in claim 1, wherein the second carcass ply extends in coherent fashion at least from one bead core to another bead core.

14. The pneumatic vehicle tire as claimed in claim 1, wherein the second carcass ply is a split ply composed of two ply parts, in that, at least from the radially outer height of each bead core, a ply part runs in a radial direction (rR) in the direction of the belt, is led as far as under the belt and ends there, and in that the two ply parts are arranged axially spaced apart from one another in the belt region.

15. The pneumatic vehicle tire as claimed in claim 1, wherein the second carcass ply at least in one tire half runs in a region of a carcass upturned portion of the first carcass ply and axially outside the carcass upturned portion of the first carcass ply.

16. The pneumatic vehicle tire as claimed in claim 1, wherein the second carcass ply at least in one tire half runs in the region of a carcass upturned portion of the first carcass ply and axially within the carcass upturned portion of the first carcass ply.

17. The pneumatic vehicle tire as claimed in claim 1, wherein the reinforcement members of the two carcass plies, with opposite gradient direction, enclose an approximately equal angle of 70° to 90°, relative the circumferential direction of the pneumatic vehicle tire.

18. The pneumatic vehicle tire as claimed in claim 1, wherein the pneumatic vehicle tire is a tire for a passenger motor vehicle.

19. The pneumatic vehicle tire as claimed in claim 1, wherein the pneumatic vehicle tire is a tire for a utility vehicle.
